(19) United States
(12) Patent Application Publication
(10) Pub. No.: US 2009/0204992 A1
(43) Pub. Date: Aug. 13, 2009

(54) Method, apparatus and system for personalized broadcast media reception

(75) Inventors: Jill MacDonald Boyce, Manalapan, NJ (US); David Brian Anderson, Florence, NJ (US); David Anthony Campana, Princeton, NJ (US); Shemimon Manalikudy Anthru, Monmouth Junction, NJ (US); Avinash Sridhar, Plainsboro, NJ (US)

Correspondence Address: Thomson Licensing LLC, P.O. Box 5312, Two Independence Way, PRINCETON, NJ, 08543-5312, US

(73) Assignee: Thomson Licensing LLC

(21) Appl. No.: 12/310,506

(22) PCT Filed: Sep. 14, 2006
(86) PCT No.: PCT/US2006/035908

§ 371 Date: Feb. 26, 2009

(51) Int. Cl. H04N 5/445

(52) U.S. Cl. 725/40

(57) ABSTRACT

The present invention advantageously provides a method, apparatus and system for personalized broadcast media content including a user interface for enabling personalization, which provides efficient use of network bandwidth and minimizes receiver device battery usage. In one embodiment, a user profile is pre-defined on a receiving device to indicate the recording interests of the user. Individual clips to be broadcast are associated with flexible metadata tags, such that when content, particularly video programs, is broadcast, the receiver device selects individual programs to record based upon content tags matching the user interests indicated in the profile. The selection process can also consider viewing statistics.

### FIELD OF THE INVENTION

The present invention generally relates to broadcast media systems and, more particularly, to a method, apparatus and system for personalizing media content reception.

### BACKGROUND OF THE INVENTION

In the world of Broadcast media, an Electronic Service Guide (ESG) contains information about television programs scheduled for broadcast. Typically an ESG includes descriptive data, or metadata, about individual programs, such as the name of the program, a synopsis, actors, director, etc., as well as the scheduled time, date, duration and channel for broadcast. For example, the DVB-H ESG provides a standardized ESG, which builds upon metadata description schemes, such as TV-Anytime. TV-Anytime defines an XML scheme for describing the metadata associated with a program. In the TV-Anytime metadata namespace, a pre-defined list of fields exists for describing various attributes of a program. Example fields in TV-Anytime include “Title”, “Genre”, “Synopsis”, and “CreditsList”. The TV-Anytime fields are hierarchical in nature. There is also a “Keyword” field in TV-Anytime.

The ESG data is typically stored on a receiver, such as a Set-Top Box (STB) or Personal Video Recorder (PVR), after the data is either broadcast or downloaded. For example, in TiVO brand PVRs, the ESG data is downloaded over the Internet and then stored locally on the PVR hard drive. A receiver device can present the ESG data to a user using a Graphical User Interface (GUI). Using the GUI, the user can browse through a list of current or future broadcast programs. As such, a user can select programs to record on local storage by browsing through a list of program names in the ESG data. The user can select to record an individual scheduled program by its name and particular air time/date/channel. When that individual selected program is broadcast, the PVR will record the associated video/audio content in local storage, for the user to view at a later time.

More specifically, using available features, a user can select to record particular programs. For example, with the TiVO Season Pass feature, a user can select to record all broadcasts of a particular program name on a particular channel. In addition, with the TiVO Wish List feature, a user can select actor names, director names, or program names of interest to be recorded.

File Delivery over Unidirectional Transport (FLUTE) is a protocol for multicast file delivery, and can be used to transmit ESG data or content over unidirectional networks. The FLUTE protocol includes a File Description Table (FDT), which describes the attributes of the files to be transmitted.

For current customer supply, several mobile video services have been deployed using cellular networks, such as Verizon VCast. These devices can connect to bidirectional mobile networks. When an individual user would like to view video on a device, the user can browse through a list of available clips. Once a particular clip is selected, a request is made to a server, and the clip data is unicast over the cellular network to the user's device. However, currently on such systems, a significant delay exists between the user selecting the clip and the beginning of the playback of the clip. In addition, such mobile devices are subject to limited storage space.

As such, a need exists for enabling users of such devices to watch personalized content on demand without user-perceived delay and to personalize the selection of content to record on a storage device, which reduces storage space and battery life requirements.

### SUMMARY OF THE INVENTION

The present invention addresses the deficiencies of the prior art by advantageously providing a method, apparatus and system for personalized broadcast media reception including, in one embodiment, a user interface for enabling the personalization of program recording, which provides efficient use of network bandwidth and minimizes receiver device battery usage.

In one embodiment of the present invention, a method for customizing the reception of media content includes determining a respective score for media content using at least received media content identification information and user profile information, and if the respective score of media content is greater than a threshold, determining if enough space is available for recording said media content. In addition, if enough space is not available for recording the media content, comparing the score of the media content to previously recorded media content and removing previously recorded media content having a score lower than the media content for accommodating the recording of the media content.

In an alternate embodiment of the present invention, a receiving device for customizing the reception of media content includes a content information parser for evaluating received media content identification information, a memory means for storing media content; and a content selection controller in communication with the content information parser for determining a respective score for the received media content identification information. In the receiving device of the present invention, if the respective score of media content is greater than a threshold, it is determined if enough space is available in the memory means for recording the media content and if enough space is not available in the memory means for recording the media content, the score of the media content is compared to previously recorded media content in the memory means and previously recorded media content having a score lower than the media content is removed from the memory means for accommodating the recording of the media content.

In an alternate embodiment of the present invention, a system for customizing the reception of media content includes a head-end device for including identification information with media content to be transmitted, a network for providing communications means for transmitting the media content, a receiving device for receiving the media content, a user interface for enabling a user to identify preferences for recording the media content, and an audio/video playing device for playing recorded media content. In one embodiment of the present invention, the receiver includes a content information parser for evaluating received media content information, a content selection controller for determining a score for received media content and for determining portions of the media content to record using the determined score and a memory means for storing media content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a broadcast video system in accordance with an embodiment of the present invention;

FIG. 2 depicts a high level block diagram of a user interface suitable for use in the broadcast video system of FIG. 1 in accordance with an embodiment of the present invention;

FIG. 3 depicts a flow diagram of a method to be performed in a head-end for personalizing broadcast video recording in accordance with one embodiment of the present invention; and

FIG. 4 depicts a flow diagram of a method to be performed in a receiver for personalizing broadcast video recording in accordance with one embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for personalized broadcast media reception. Although the present invention will be described primarily within the context of a broadcast video network environment, the specific embodiments of the present invention should not be treated as limiting the scope of the invention. It will be appreciated by those skilled in the art and informed by the teachings of the present invention that the concepts of the present invention can be advantageously applied in any environment for personalizing the reception of media content including audio and video images.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

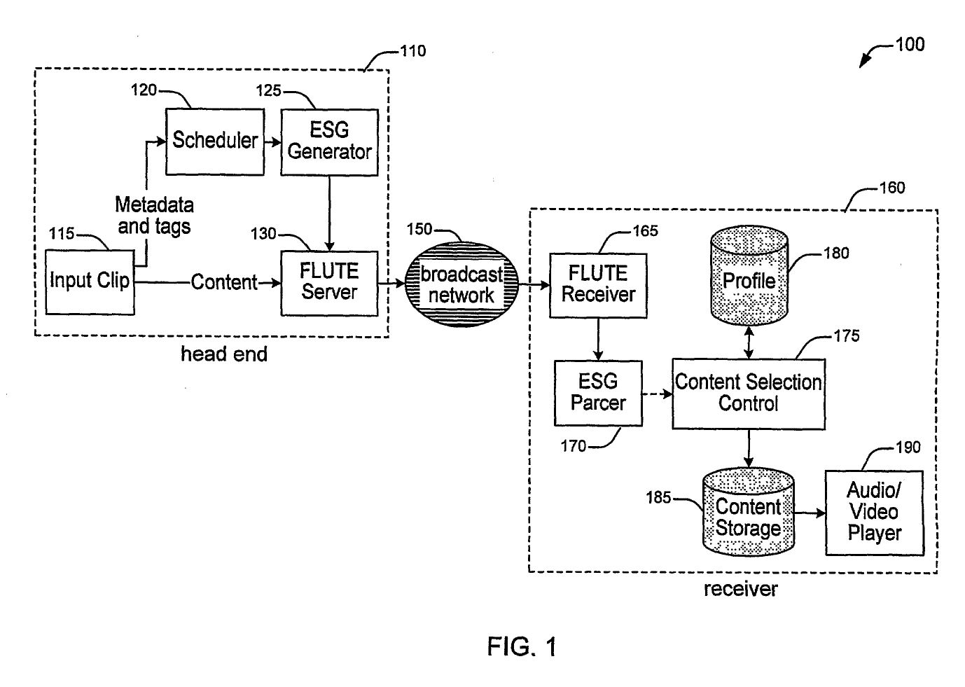

For example, FIG. 1 depicts a high level block diagram of a broadcast video system in accordance with an embodiment of the present invention. The broadcast video system 100 of FIG. 1 illustratively comprises a head end 110, a broadcast network 150 and a receiver 160. The head end 110 of the broadcast video system 100 of FIG. 1 illustratively comprises an input clip 115, a scheduler 120, an electronic service guide (ESG) generator 125 and a Flute Server 130. The receiver 160 of the broadcast video system 100 of FIG. 1 illustratively comprises a receiving device (illustratively a Flute Receiver) 165, an information parser (illustratively an ESG parser) 170, a content selection controller 175, a memory means (illustratively a content storage device) 185 and an audio/video player 190. As depicted in the broadcast video system 100 of FIG. 1, the receiver 160 further comprises a means 180 (e.g., a user interface) for communicating a user profile to the content selection controller 175.

The broadcast video system 100 of FIG. 1 can be used for recording short-form content, shorter than a typical broadcast television program, or for recording full-length television programs. The term “clip” will be used herein to describe a particular piece of content. The various embodiments of the present invention enable a user to set up a profile indicating what type of content the user is interested in recording. As such, when content matching that profile is broadcast using, for example, a flexible selection method, a receiver of the present invention will record the content automatically, without requiring any active participation on the part of the user. Subsequently, when the user is interested in watching video, the receiver device presents via, for example a user interface (e.g., graphical user interface (GUI)) 180, a listing of all of the content stored on the device. The user then selects a clip for playback. Playback can then begin immediately without a delay. In accordance with various embodiments of the present invention, power usage can be reduced by not receiving clips that are not of interest to a user and as such are not to be recorded. The receiver 160 can enter a sleep mode during the time when clips not of interest are being broadcast in order to minimize battery usage, and return to an awake mode when necessary to receive clips that have been selected for recording or for receiving electronic service guide (ESG) updates.

In the broadcast video system 100 of FIG. 1, at the head end 110, one or more tags, e.g. keywords, are associated with each individual clip 115, as part of the meta-data which describes that particular clip 115. It should be noted, however, that there can be several clips that correspond to a particular event, such as a baseball game. More specifically, in the ESG generator 125 of the head end 110, an ESG schema is used that not only includes fixed fields in a predefined hierarchy, which correspond to particular attributes (e.g. program name, director name, size field, etc), but also includes tags, which do not follow any particular hierarchy. The ESG can also extend to incorporate timing fields corresponding to when the content was created rather than when it was broadcast. The ESG can also extend to incorporate a field indicating that a clip is a member of an associated group of clips. This ESG data (e.g., identification information) is broadcast periodically to many receiver devices, over any type of wired or wireless, unidirectional or bi-directional network such as the broadcast network 150 depicted in FIG. 1. In accordance with the present invention, the identification information can be used to identify the clip (media content portion) including an amount of space needed in a memory means for storing that particular clip. In various embodiments of the present invention, the broadcast network can comprise a cellular network and the receiver can comprise a mobile communications device. In an embodiment of the present invention, the metadata (identification information) is attached to the clip in addition to or instead of the metadata being included in the ESG.

When a clip and its associated tags are ingested at the head end, the clip is scheduled for broadcast at a later time by the Scheduler 120. The ESG data to be broadcast is updated to contain identification information about the newly added clip (e.g. its metadata and its scheduled broadcast time and channel, a size field, etc). An individual clip can be broadcast more than once. The ESG data to be broadcast is updated to contain the information for all of the times that the individual clip is to be broadcast. In addition, a variety of different clips may be added to the system. Each clip is broadcast at its scheduled time. The clips can be broadcast over the same network as the ESG data, or over a different network. That is, although in the broadcast video system 100 of FIG. 1, the ESG data and the various clips are depicted as being broadcast by the FLUTE server 130 over the broadcast network 150, in alternate embodiments of the present invention, the ESG data and the content data can be communicated to a receiver using different communications channels or networks. As depicted in FIG. 1, the FLUTE server 130 can be used to broadcast the ESG data and/or the clips themselves.

At the receiver 160, an individual user specifies in advance the type of content preferences he/she is interested in viewing. This information can be stored as a profile on the user's receiver device. These preferences can be indicated as interest items, which are similar to the tags associated with the clips at the head end. Alternatively, the preferences can be search query terms, which allow for search combinations or negative search terms. In one embodiment of the present invention, the means 180 for communicating a user profile to the content selection controller 175 is a user interface 180. The user interface 180 of the receiver 160 of the broadcast video system 100 of FIG. 1 can comprise wireless remote controls, pointing devices, such as a mouse or a trackball, voice recognition systems, touch screens, on screen menus, buttons, knobs and the like. In addition, the user interface 180 may be provided directly on the receiver 160 or on a remote panel or device.

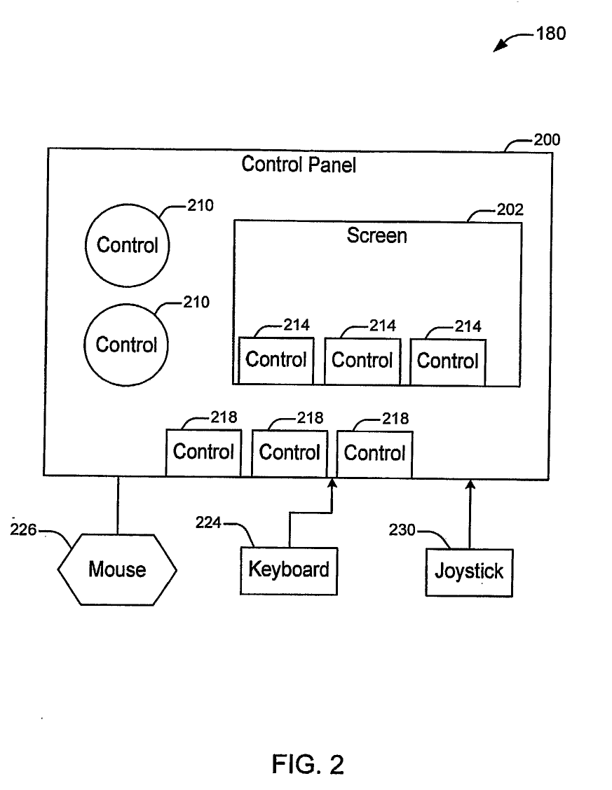

For example, FIG. 2 depicts a high level block diagram of a user interface 180 suitable for use in the broadcast video system 100 of FIG. 1 in accordance with an embodiment of the present invention. As described above, the user interface 180 is provided for communicating a user profile to the content selection controller 175 in accordance with an embodiment of the present invention. The user interface 180 of FIG. 2 can be a stand alone workstation including a control panel 200 having a screen or display 202 or can be implemented in software as a graphical user interface on a computer. Controls 210-226 can include actual knobs/sticks 210, keypads/keyboards 224, buttons 218-222 virtual knobs/sticks and/or buttons 214, a mouse 226, a joystick 230 and the like, depending on the implementation of the user interface 180.

Referring back to FIG. 1, the receiver 160 periodically receives the ESG data via, for example, the ESG parser 170 and stores it locally on, for example, the content storage device 185. After updated ESG data is received, the content selection controller 175 of the receiver 160 selects which clips should be recorded locally, based on matching tags of the broadcast clip with the interest information of the user defined by the profile. A more sophisticated scoring system can also be used to select which clips to record. The process of selecting if a clip will be recorded can be done anytime after an ESG update is received containing a reference to a particular clip. For example, ESG data can be received before a particular clip is due to be received and as such a decision to record or to not record a clip can be made prior to receiving a clip. As such, power usage can be reduced by not receiving clips that are not to be recorded. For example, the receiver 160 can enter a sleep mode during the time when clips not of interest are being broadcast in order to minimize battery usage, and return to an awake mode when necessary to receive ESG updates or clips that have been selected for recording. That is, in one embodiment of the present invention a receiver can use timing information in the ESG to know when to turn on and off. In sleep mode, the receiver functionally can be disabled. When a clip that has been selected for recording is scheduled for broadcast, the receiver 160 is activated to receive the clip being broadcast. When the start of the broadcast of the selected clip is detected by, for example using the FLUTE receiver 165 of the receiver 160 to identify the selected clip, the receiver 160 begins to record the clip and store it in the local content storage device 185.

In an alternate embodiment of the present invention, the ESG data can be received at the same time as the content (clip) and as such, a decision to record or not to record content can be made at the time the content is received. In such embodiments of the present invention, storage space is conserved by not recording content that is not preferred or selected by a user.

In various instances, it is possible that the local content storage device 185 will not have sufficient available space to store the selected clip. The “Storage” field of the DVB-H ESG can be used to determine the size of the clip to be broadcast. If insufficient space is available in the local content storage device 185, the receiver 160 can either decide to not record the new clip, or to remove one or more clips already stored in local storage. Typically, the “Storage” field of the DVB-H ESG is in units of Mbytes, which is somewhat imprecise, so the actual sizes of the stored clips can be used instead for determining available space in local storage.

In accordance with various embodiments of the present invention, in order to reduce battery usage, a display screen (not shown) of, for example, the audio/video player 190 may be turned off during the ESG and clip reception process. In one embodiment of the present invention, the display screen is turned on only when a user is actively using the audio/video player 190 to view a clip.

In one embodiment of the present invention, active user participation in the video personalization process is necessary only to set up a profile in advance, which can be done once, or updated as desired. The additional clip selection process is done automatically by the receiver 160. The profile can be setup in many different ways, either on the device itself, or separately on a computer connected to, for example, the Internet. The user can select items of interest from a list presented to the user, or can enter free text interest items. An interest item can be equivalent to a tag that is associated with a clip.

One embodiment of a process for selecting which clips to record is described in more detail below. For example, the association of flexible tags with individual clips and a user-specified interest profile allows for great flexibility. For example, user, A, may be interested in baseball and, in particular, in the team the New York Yankees. As such, in one embodiment, “Yankees” would be stored as an interest item in the profile on the user's receiver 160. Another user, B, might be interested in the Boston Red Sox. As such, in one embodiment, “Red Sox” would be stored as an interest item in the profile of the user B's receiver 160. A third user, C's, favorite team is the Kansas City Royals and wishes to record items if interest including the Kansas City Royals, however the user is also interested in highlights for all of the major league baseball teams. As such, in one embodiment of the present invention, user C's profile would include interest items for “Royals” and “MLB highlights”.

For example, if a clip scheduled for broadcast includes a grand slam homerun highlight in a game between the Yankees and the Red Sox, the metadata for that clip may includes the tags “Yankees”, “Red Sox” and “MLB highlights”, which is included in the ESG data. As such, when the receivers of users A, B, and C receive the ESG data describing that clip, all three receivers of users A, B, and C will select to record that clip, because they will each have at least one interest item that matches at least one tag associated with the clip. That is, when the clip is broadcast, it will be recorded on all three receivers.

In accordance with the present invention, the matching of interest items and clip tags can be done using an exact match, or can be matched without requiring an exact match, for example if the interest item text is contained anywhere in a clip tag, for example, “MLB” matches “MLB highlights,” or if the interest item text is contained in other metadata associated with a clip, such as a synopsis of the clip. However, in accordance with alternate embodiments of the present invention, more sophisticated matching schemes can be implemented than the simple one described above where content is recorded if any of the profile interest items matches any of the clip tags. Search queries that include combinations and/or negative terms can also be used.

In alternate embodiments of the present invention, more flexible matching schemes can be implemented for scoring individual clips based on the user profile. For example, relative scores can be used to decide whether a new clip to be broadcast should be recorded and replace in storage one or more existing clips, based on whether the new clip or the existing clips has a higher score. One or more existing clips with the lowest scores are deleted, based on the amount of free space in local storage and the sizes of the new clip and the existing lowest scoring clips. Individual clips will be of different sizes, so as many existing clips with lower scores as necessary will be deleted in order to create space to store a new clip. The scores of the existing clips with lowest scores can be combined together to determine a total score of the existing clips that would be removed, for example with the total score being the sum of the clip scores or the average of the clip scores. The total score of the existing clips can be compared with the score of the new clip, and if the score of the new clip is higher than the total score of the existing clips, the lowest scoring existing clips are deleted and the new clip is recorded.

When determining whether a new clip should be recorded at the expense of an already stored clip, a small bias can be given to the score of the existing clips, to avoid constantly storing new clips and replacing old clips, which can use a lot of battery life in a client device. In such embodiments, the score of the new clip would have to exceed the total score of the existing clips by a threshold in order for the new clip to be selected to be recorded.

Even further, the score calculation can consider the interest items in the user profile, which can each be individually rated by the user when the profile is set up. The score calculation can also consider age of the clip in local storage, for example the score of a particular clip will become lower over time as it becomes older. Additionally, the score calculation can consider the viewing statistics of the user, for example, what content associated with certain tags is most frequently viewed.

Subsequently, when a user wishes to view video on the device, the user interface 180 presents a list of the clips recorded in local storage. The list of clips can be presented in a variety of different ways, such as grouping by tags, or by score, or by how recently the content was created or received. Associated groups of clips can be presented together to the user, in the order in which they were created.

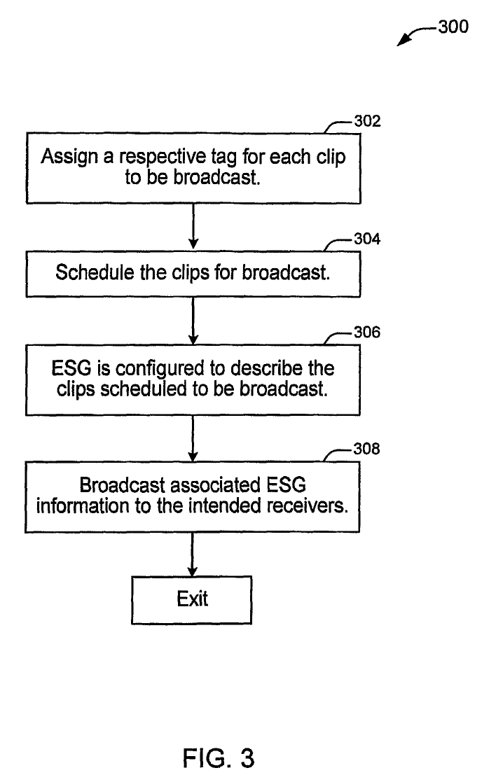

FIG. 3 depicts a flow diagram of a method to be performed in a head-end for personalizing broadcast video recording in accordance with one embodiment of the present invention. The method 300 of FIG. 3 begins in step 302 in which a respective tag is assigned for each clip to be broadcast. The method 300 then proceeds to step 304.

At step 304, the clips to be broadcast are scheduled for broadcast. The method 300 then proceeds to step 306.

At step 306, the ESG is configured and updated to include the clips scheduled to be broadcast. In the ESG respective descriptive data, or metadata, about individual clips, such as the name of the program, a synopsis, actors, director, etc., as well as the scheduled time, date, duration and channel are stored. The method 300 then proceeds to step 308.

At step 308, the ESG/identification information is broadcast to the intended receivers. The method 300 then ends.

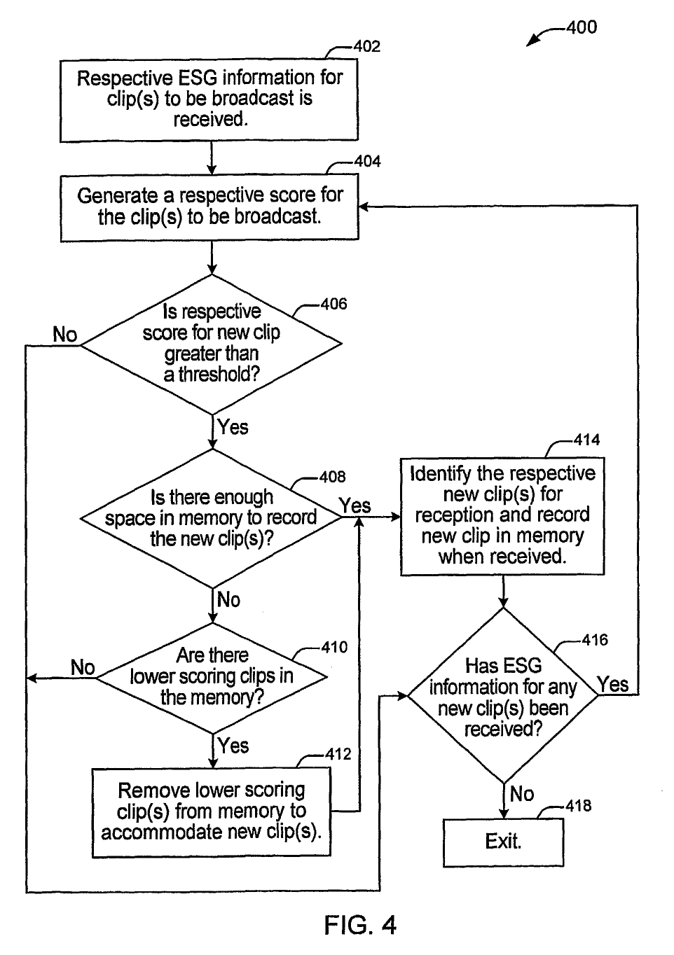

FIG. 4 depicts a flow diagram of a method to be performed in a receiver for personalizing broadcast video recording in accordance with one embodiment of the present invention. The method 400 of FIG. 4 begins in step 402 in which respective ESG information is received for the clips to be broadcast. The method 400 then proceeds to step 404.

At step 404, the respective ESG information for the new clip(s) is compared to a user preference list and ranked (i.e., given a score) according to how well the respective ESG information matches one or more selections in the user preference list. The method 400 then proceeds to step 406.

At step 406, it is determined if the score for the new clip is greater than a predetermined threshold. That is, as described above, a threshold score or rank is determined for identifying those clips which a user prefers to record. If the score of a respective clip is not greater than the predetermined threshold, the method 400 skips to step 416. If the score of a respective clip is greater than the predetermined threshold, the method 400 proceeds to step 408.

At step 408, it is determined if there is available space in a local storage greater than or equal to the size of the new clip to be recorded. If there is not enough space for storing the present clip to be recorded the method 400 proceeds to step 410. If there is enough space in local storage for recording the clip, the method 400 skips to step 414.

At step 410, the score of the new clip to be recorded is compared to all existing clips in the local memory. If there are lower scoring clips in the local storage the method 400 proceeds to step 412. If lower scoring clips do not exist in the local storage, the method 400 proceeds to step 416.

At step 412, lower scoring clips are removed to accommodate the recording of the new clip. In one embodiment of the present invention, the lowest scoring clips in the local storage are removed until there is enough space in the local storage to record the new, higher scoring clip. In an alternate embodiment of the present invention, a lowest scoring clip that has a size equal to or greater than the size of the new clip to be recorded is removed for accommodating the recording of the new clip. The method 400 then proceeds to step 414.

At step 414, the respective clip is identified as a clip to be received and recorded. The method 400 then proceeds to step 416.

At step 416, it is determined if ESG information for any other new clips have been received. If no ESG information for any other clips have been received, the method 400 proceeds to step 418. If at least one other new clip has been received, the method 400 returns to step 404.

At step 418, the method 400 is exited.

Having described preferred embodiments for a method, apparatus and system for personalized broadcast media reception (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for customizing the reception of media content, comprising:
determining a respective score for media content using at least received media content identification information;
if the respective score of media content is greater than a threshold, determining if enough space is available for recording said media content;
if enough space is not available for recording said media content, comparing the score of said media content to previously recorded media content and removing previously recorded media content having a score lower than said media content for accommodating the recording of said media content.

2. The method of claim 1, wherein the score for the media content is determined according to how closely the media content identification information matches one or more selections in a user preference list.

3. The method of claim 2, wherein the score for the media content is determined by further considering a weighting assigned to a particular type of media content.

4. The method of claim 3, wherein said weighting is determined by considering how often a particular type of media content is selected for recording.

5. The method of claim 2, wherein said user preference list identifies user preferences for media content to be recorded.

6. The method of claim 1, wherein said media content identification information is received prior to receiving said media content.

7. The method of claim 1, wherein if the score of the media content is not greater than the threshold, the media content is not received or recorded.

8. The method of claim 1, wherein if enough space is available in a memory for recording said media content and the score of said media content is greater than a threshold, said media content is recorded in said memory without removing any previously recorded media content.

9. The method of claim 1, wherein said media content identification information is received prior to a broadcast of said media content.

10. The method of claim 1, wherein said media content identification information is received along with said media content.

11. The method of claim 1, wherein said media content identification information comprises an electronic service guide.

12. The method of claim 1, wherein when it is determined that media content is not to be recorded a power consumption of a receiving device is reduced.

13. The method of claim 12, wherein said receiving device is in a sleep mode.

14. The method of claim 1, wherein recorded content is grouped for display according to content identification information.

15. The method of claim 14, wherein said content identification information comprises tags and said recorded content is grouped for display according to tag groupings.

16. A receiving device for customizing the reception of media content, comprising:
a content information parser for evaluating received media content identification information;
a memory means for storing media content; and
a content selection controller in communication with said content information parser for determining a respective score for the received media content identification information;
wherein, if the respective score of media content is greater than a threshold, it is determined if enough space is available in said memory means for recording said media content and if enough space is not available in said memory means for recording said media content, the score of said media content is compared to previously recorded media content in said memory means and previously recorded media content having a score lower than said media content is removed from said memory means for accommodating the recording of said media content.

17. The receiving device of claim 16, comprising a user interface.

18. The receiving device of claim 17, wherein said user interface comprises at least one of a wireless remote control, a pointing device, such as a mouse or a trackball, a voice recognition system, a touch screen, on screen menus, buttons, and knobs.

19. The receiving device of claim 17, wherein said user interface enables a user to identify preferences for recording said media content.

20. The receiving device of claim 16, comprising an audio/video playing device for playing recorded media content.

21. The receiving device of claim 16, wherein said media content identification information comprises electronic service guide information.

22. The receiving device of claim 21, wherein said content information parser comprises an electronic service guide parser.

23. The receiving device of claim 16, wherein if a respective score for media content is not greater than a threshold, said media content is not received by said receiving device.

24. The receiving device of claim 23, wherein if it is determined that media content is not to be received a power consumption of said receiving device is reduced.

25. The receiving device of claim 24, wherein said receiving device is in a sleep mode.

26. The receiving device of claim 25, wherein recorded content is grouped for display according to content identification information.

27. The receiving device of claim 26, wherein said content identification information comprises tags and said recorded content is grouped for display according to tag groupings.

28. A system for customizing the reception of media content, comprising:
a head-end device for including identification information with media content to be transmitted;
a network for providing a communications means for the transmission of said media content;
a receiving device for receiving said media content, said receiver including:
a content information parser for evaluating received media content identification information;
a memory means for storing media content; and
a content selection controller in communication with said content information parser for determining a respective score for the received media content identification information;
a user interface for enabling a user to identify preferences for recording said media content; and
an audio/video playing device for playing recorded media content;
wherein, if the respective score of media content is greater than a threshold, it is determined if enough space is available in said memory means for recording said media content and if enough space is not available in said memory means for recording said media content, the score of said media content is compared to previously recorded media content in said memory means and previously recorded media content having a score lower than said media content is removed from said memory means for accommodating the recording of said media content.

29. The system of claim 28, wherein said identification information comprises electronic service guide information.

30. The system of claim 28, wherein said network comprises a broadcast network.

31. The system of claim 28, wherein said head-end device comprises an electronic service guide generator for generating identification information for said media content.

32. The system of claim 28, wherein said receiving device comprises a mobile communications device.

33. The system of claim 28, wherein said identification information comprises a size field and an amount of space needed for recording received media content is determined from said size field.
